(19) United States
(12) Patent Application Publication
(10) Pub. No.: US 2026/0172278 A1
(43) Pub. Date: Jun. 18, 2026

(54) HYBRID FIBER-COAXIAL NETWORKS

(71) Applicant: ARRIS Enterprises LLC, Horsham, PA (US)

(72) Inventors: David GRUBB, Bethlehem, PA (US); Gary PICARD, Carlisle, MA (US); David BOWLER, Stow, MA (US)

(73) Assignee: ARRIS Enterprises LLC, Horsham, PA (US)

(21) Appl. No.: 19/360,792

(22) Filed: Oct. 16, 2025

Related U.S. Application Data
(63) Continuation of application No. 18/271,601, now abandoned.
(60) Provisional application No. 63/140,443, filed on Jan. 22, 2021.

(51) Int. Cl. H04L 12/28; H02G 15/06; H04B 10/25; H04B 10/80

(52) U.S. Cl. CPC H04L 12/2869; H02G 15/06; H04B 10/25; H04B 10/806

(57) ABSTRACT

Nodes, amplifiers, and taps for an improved hybrid fiber-coaxial (HFC) network and methods for managing signals in an improved HFC network are shown and disclosed. The method may include receiving, at a node, a downstream optical signal in a higher-frequency band and a lower-frequency band separated from the higher-frequency band. The method may additionally include amplifying, at the node, the lower-frequency band by a magnitude different than that of the higher-frequency band. The method may further include combining, at the node, the higher-frequency band and the lower-frequency band into an output signal after the lower-frequency band has been amplified.

### CROSS REFERENCE TO RELATED APPLICATIONS

This application is a continuation of U.S. patent application Ser. No. 18/271,601, filed Jul. 10, 2023, which is a national stage application of PCT Application Serial Number PCT/US 22/19627 filed Mar. 9, 2022, which claims the benefit of U.S. Provisional Patent Application Ser. No. 63/140,443 filed Jan. 22, 2021.

### BACKGROUND

The subject matter of this application relates to hybrid fiber-coaxial networks.

In a hybrid fiber-coaxial (HFC) network, the television channels and other content and/or data are routed from the cable system's distribution facility (the headend) to local communities through optical fiber subscriber lines. At the local community, a box called an optical node translates the signal from a light beam to radio frequency (RF), and routes it over coaxial cable lines for distribution to subscribers.

HFC networks are typically operated so that signals are carried in both directions on the same network from the headend to the subscribers, and from the subscribers to the headend. The forward-path or downstream signals carry information from the headend to the subscribers, such as video content, voice, and Internet data. The return-path or upstream signals carry information from the subscribers to the headend, such as control signals to order a movie or Internet data to route an e-mail. The forward-path and the return-path are carried over the same coaxial cable in both directions between the optical node and the subscribers.

Currently, the bandwidth demands are ever increasing because of various drivers, such as the increasing popularity of social media and streaming video and the increasing number of Internet connected devices per subscriber. While traditional node splitting has led to some increases in bandwidth, there is more pressure to further increase bandwidth to support bi-directional gigabit services while still supporting services from legacy systems, such as quadrature amplitude modulation (QAM) set-top boxes (STBs), digital TV adapters (DTAs), and existing Data Over Cable Service Interface Specification (DOCSIS) modems. What is desired, therefore, is an improved HFC network that supports bi-directional gigabit services while supporting legacy systems.

### BRIEF DESCRIPTION OF THE DRAWINGS

For a better understanding of the invention, and to show how the same may be carried into effect, reference will now be made, by way of example, to the accompanying drawings, in which:

FIG. 1 is a high-level block diagram of an example of a HFC network.

FIG. 2 is a block diagram of an example of a node of the HFC network of FIG. 1.

FIG. 3 is a block diagram of another example of a node of the HFC network of FIG. 1.

FIG. 4 is a block diagram of an example of a tap of the HFC network of FIG. 1.

FIG. 5 is a block diagram of an example of an amplifier of the HFC network of FIG. 1.

FIG. 6 is a flowchart of an example of a method of managing signals in a HFC network.

### DETAILED DESCRIPTION

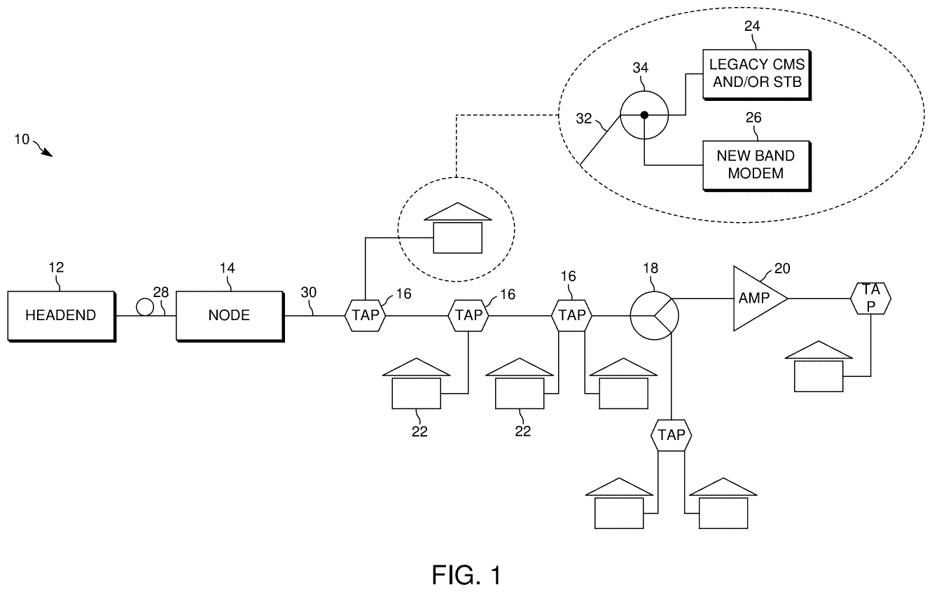

Referring to FIG. 1, an illustrative example of an improved HFC network 10 is shown. The HFC network includes a hub or headend 12, nodes 14, taps 16, splitters 18, and amplifiers 20. Although only a single node 14 and a single splitter 18 is shown in FIG. 1, HFC network 10 may include multiple nodes 14 and multiple splitters 18. HFC network 10 delivers signals from headend 12 to customer premises equipment (CPE) of network subscribers 22, and from the CPE to the headend. The CPE includes legacy content management systems and/or set-top boxes 24 and new band modems 26. Headend 12 is connected to nodes 14 via fiber optic lines 28, which may carry analog and/or digital optical streams. Nodes 14 are connected to amplifier apparatus or amplifier 20 and tap apparatus or taps 16 via coaxial cables 30. Taps 16 are linked to the CPE via specific drop cables 32 and outlets 34. Although only a single amplifier 20 is shown, HFC network 10 may include multiple amplifiers 20.

HFC network 10 divides the spectrum into four bands, namely a legacy upstream band, a legacy downstream band, a new upstream band, and a new downstream band. The HFC network amplifies the legacy upstream band and/or the legacy downstream band by a magnitude different than that of the new upstream band and/or the new downstream band. For example, at least in some components of HFC network 10, amplification of the legacy upstream band and/or the legacy downstream band may be greater than amplification of the new upstream band and/or the new downstream band. In one or more components of HFC network 10, the new upstream band and/or the new downstream band may not be amplified while the legacy upstream band and/or the legacy downstream band may be amplified. In one or more other components of HFC network 10, the new upstream band and/or the new downstream band may be amplified while the legacy upstream band and/or the legacy downstream band may be less amplified or not amplified. In those components where the new upstream band and/or the new downstream band are amplified more than the legacy upstream band and/or the legacy downstream band, the amplification of the new upstream band and/or the new downstream band may be in amount(s) less than the amplification of the legacy upstream band and/or the legacy downstream band in other components of HFC network 10.

HFC network 10 amplifies the new upstream band and/or the new downstream band more often but at lower amplification level(s) along the network, such as at the node, the amplifiers, and/or the taps. HFC network 10 may thus sometimes be referred to as providing “distributed gain” to the new upstream band and/or new downstream band. For example, other HFC networks may include about 1000 feet between components that amplify the signals (e.g., amplifiers), while HFC network 10 includes a maximum of 600 feet between components that amplify the signals.

In the example shown in FIG. 1, the legacy upstream band may be any one of the following about 5 MHz to about 42 MHz, about 5 MHz to about 65 MHz, about 5 MHz to about 85 MHz, about 5 MHz to about 204 MHz, and about 8 MHz to about 85 MHz, which includes Data Over Cable Service Interface Specification (DOCSIS) upstream signals, and Society of Cable Telecommunications Engineer (SCTE) 55-1 and 55-2 protocol upstream signals. The legacy downstream band may be any one of the following: about 55 MHz to about 330 MHz, about 55 MHz to about 400 MHz, about 85 MHz to about 330 MHz, about 85 MHz to about 400 MHz, about 108 MHz to about 300 MHz, about 108 MHz to about 492 MHz, and about 108 MHz to about 684 MHz, which includes set-top box (STB) out-of-band (OOB) downstream signals, 16-24 quadrature amplitude modulation (QAM) video signals, and 16-32 DOCSIS QAM signals. The new upstream band is about 450 MHz to about 900 MHz, while the new downstream band is about 1000 MHz to about 1800 MHz. However, the frequency bands above are merely illustrative and can be different (e.g., moved higher) if more capacity is required. When the ranges for the legacy and new band are the same or similar as described above, the legacy band may be referred to as “lower-frequency band” or “lower-frequency,” while the new band may be referred to as a “higher-frequency band” or “higher-frequency.”

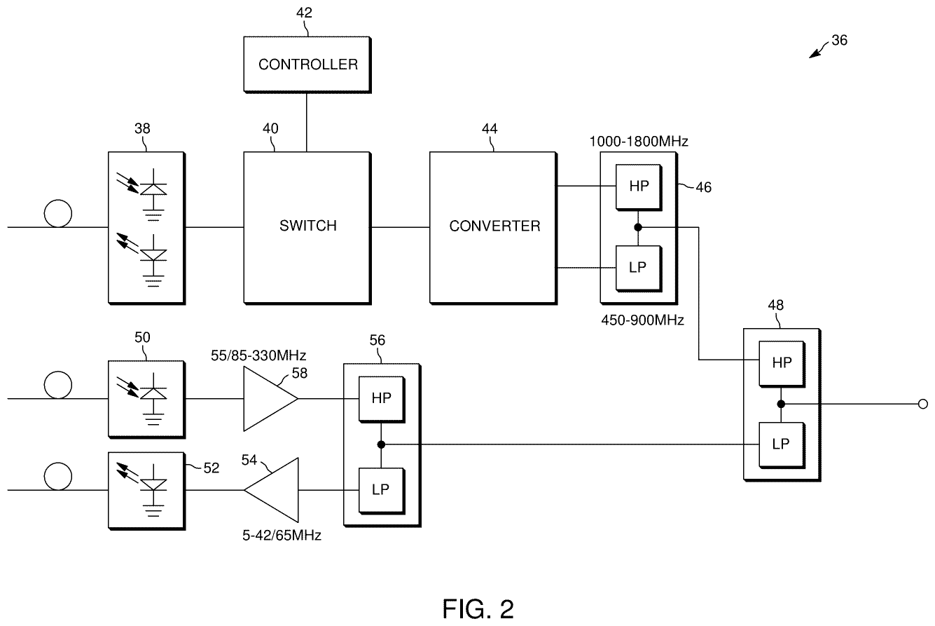

Referring to FIG. 2, an example of node 14 is shown, which is generally indicated at 36. Unless explicitly excluded, node 36 may include one or more components of one or more other nodes described in the present disclosure. Node 36 receives and transmits analog optical streams from and to the headend. Node 36 includes a transceiver 38 that receives optical new band downstream streams from the headend and converts those streams to digital new band downstream signals, and converts digital new band upstream signals to optical new band upstream streams and transmits those streams to the headend. The transceiver may include any suitable structure, such as one or more laser diodes and/or photodiodes. In the example shown in FIG. 2, transceiver 38 is a small form-factor pluggable (SFP) transceiver having one or more laser diodes and one or more photodiodes.

Node 36 also includes a switch 40 (such as an Ethernet switch) and a controller 42 that controls the switch. Switch 42 manages and reduces the noise of the digital new band upstream and downstream signals between transceiver 38 and a converter 44. Controller 42 may be a local controller or a remote controller. Converter 44 converts the digital new band downstream signals to analog QAM new band downstream signals. Additionally, the converter converts the analog QAM new band upstream signals to digital new band upstream signals. In some examples, converter 44 may amplify the digital new band upstream and/or downstream signals during and/or separate from the conversion process. In other examples, converter 44 does not amplify the digital new band upstream and/or downstream signals. An example of converter 44 is a modulator/demodulator (or modem).

Node 36 further includes a second filter 46 disposed between a first filter 48 and converter 44. The second filter receives analog QAM new band upstream signals from the first filter and routes those signals to converter 44, and receives analog QAM new band downstream signals from converter 44 and routes those signals to first filter 48. Node 36 additionally includes first filter 48 that receives analog QAM new band upstream signals and route those signals to second filter 46, and receives analog QAM new band downstream signals from second filter 46 and route those to components downstream of the node. In other words, first filter 48 separates analog QAM new band upstream signals from analog QAM legacy upstream signals for separate processing by other components of node 36.

Node 36 further includes one or more photodiodes 50 and one or more laser diodes 52. Photodiode(s) 50 receive analog optical downstream streams from the headend and convert those streams to analog QAM legacy downstream signals. Laser diode(s) 52 receive analog QAM legacy upstream signals, convert those signals to analog optical upstream streams, and route those streams to the headend. Photodiodes 50 and laser diodes 52 may collectively be referred to as a “transceiver” separate from transceiver 38.

Node 36 additionally includes a first amplifier 54 that receives and amplifies analog QAM legacy upstream signals from a third filter 56, and a second amplifier 58 that receives and amplifies analog QAM legacy downstream signals from photodiode(s) 50. The first and/or second amplifiers may amplify the analog QAM legacy signals by a magnitude different than that of the analog QAM new band signals. In some examples, the amplification of the analog QAM legacy signals at the first and/or second amplifiers is greater than amplification of the analog QAM new band signals at node 36. For example, the first and second amplifiers may amplify the analog QAM legacy downstream and upstream signals by a gain of 25 dB and 15 dB, respectively. In contrast, converter 44 may amplify the analog QAM new band downstream and upstream signals by a gain of 45 dB and 25 dB, respectively. In some examples, node 36 (including converter 44) does not amplify the analog QAM new band signals.

Node 36 additionally includes third filter 56 disposed between the first filter and the first and second amplifiers. The third filter receives analog QAM legacy upstream signals and routes those signals to first amplifier 54. Third filter 56 also receives analog QAM legacy downstream signals from second amplifier 58 and routes those signals to first filter 48. First filter 48 combines the analog QAM new band signals and the analog QAM legacy downstream signals.

As an example, optical new band downstream streams are received by node 36 at transceiver 38 and converted to digital new band downstream signals. Switch 40 and controller 42 reduce the noise of the digital new band downstream signals, which are then converted to analog QAM new band downstream signals via converter 44 and then routed through second filter 46 and first filter 48 to combine with the analog QAM legacy downstream signals and to components downstream of node 36. Similarly, analog QAM new band upstream signals are received at first filter 48, routed to second filter 46, and then converted to digital new band upstream signals by converter 44. Switch 40 and controller 42 reduce the noise of the digital new band upstream signals and those signals are converted to optical new band upstream streams and are transmitted to the headend.

Legacy downstream optical streams are received by photodiode(s) 50 and are converted to analog QAM legacy downstream signals. Those signals are amplified by second amplifier 58 and then routed through third filter 56 and first filter 48 to combine with the analog QAM new band downstream signals and to components downstream of node 36. Similarly, analog QAM legacy upstream signals are received by first filter 48 and routed to third filter 56 and then amplified by first amplifier 54. The amplified signals are converted to optical legacy upstream streams via laser diode(s) 52 and routed to the headend.

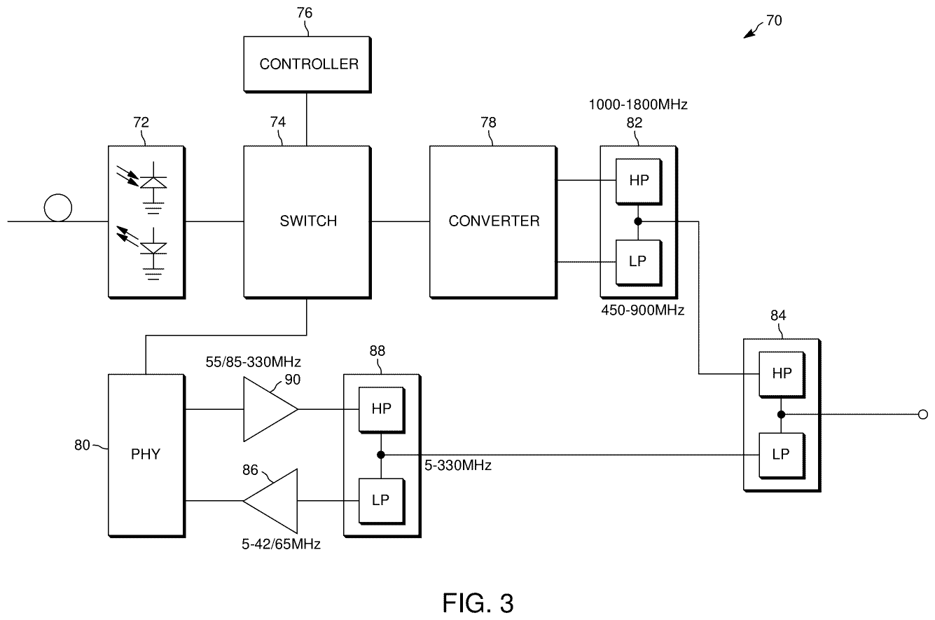

Referring to FIG. 3, another example of node 14 is shown, which is generally indicated at 70. Unless explicitly excluded, node 70 may include one or more components of one or more other nodes described in the present disclosure, such as node 36. Unlike node 36, node 70 receives and transmits digital optical streams from and to the headend. Node 70 includes a transceiver 72 that receives optical downstream streams from the headend and converts those streams to digital downstream signals, and converts digital upstream signals to optical upstream streams and transmits those streams to the headend. The transceiver may include any suitable structure, such as one or more laser diodes and/or photodiodes. In the example shown in FIG. 3, transceiver 38 is a small form-factor pluggable (SFP) transceiver having one or more laser diodes and one or more photodiodes.

Node 70 also includes a switch 74 (such as an Ethernet switch) and a controller 76 that controls the switch. Switch 74 manages and reduces the noise of the digital upstream and downstream signals between transceiver 72, a converter 78, and a physical layer (PHY) device 80. For example, switch 74 routes digital new band downstream signals to converter 78 and routes digital legacy downstream signals to PHY device 80. Additionally, switch 74 routes digital upstream signals from converter 78 and PHY device 80 to transceiver 72. Controller 76 may be a local controller or a remote controller. Converter 78 converts digital new band downstream signals from switch 74 to analog QAM new band downstream signals, and converts the analog QAM new band upstream signals to digital new band upstream signals. In some examples, converter 78 may amplify the digital new band upstream and/or downstream signals during and/or separate from the conversion process. In other examples, converter 78 does not amplify the digital new band upstream and/or downstream signals. An example of converter 78 is a modulator/demodulator (or modem).

Node 70 further includes a second filter 82 disposed between a first filter 84 and converter 78. The second filter receives the analog QAM new band upstream signals from the first filter and routes those signals to converter 78, and receives analog QAM new band downstream signals from converter 78 and routes those signals to first filter 84. Node 70 additionally includes first filter 84 that receives analog QAM new band upstream signals and route those signals to second filter 82, and receives analog QAM new band downstream signals from second filter 82 and route those to components downstream of node 70. First filter 84 also receives analog QAM legacy upstream signals and routes those signals to a third filter 88, and receives analog QAM legacy downstream signals and routes those signals to components downstream of node 70. In other words, first filter 84 separates the analog QAM new band upstream signals from the analog QAM legacy upstream signals for separate processing by other components of node 70.

Node 70 further includes PHY device 80 that receives digital legacy downstream signals from switch 74 and converts those signals to analog QAM legacy downstream signals, and receives analog QAM legacy upstream signals and converts those signals to digital legacy upstream signals. PHY device 80 may include one or more system-on-a-chip devices [SoC(s)].

Node 70 additionally includes a first amplifier 86 that receives and amplifies analog QAM legacy upstream band signals from third filter 88, and a second amplifier 90 that receives and amplifies analog QAM legacy downstream signals from PHY device 80. The first and/or second amplifiers may amplify the analog QAM legacy signals by a magnitude different than that of the analog QAM new band signals. In some examples, the amplification of the analog QAM legacy signals at the first and/or second amplifiers is greater than amplification of the analog QAM new band signals at node 70. For example, the first and second amplifiers may amplify the analog QAM legacy signals by a gain of 25 dB and 15 dB, respectively. In contrast, converter 78 may amplify the analog QAM new band downstream and upstream signals by a gain of 45 dB and 25 dB, respectively. In some examples, node 36 (including converter 44) does not amplify the analog QAM new band signals.

Node 70 additionally includes third filter 88 disposed between the first filter and the first and second amplifiers. The third filter receives analog QAM legacy upstream signals and routes those signals to first amplifier 86. Third filter 88 also receives analog QAM legacy downstream signals from second amplifier 90 and routes those signals to first filter 84.

As an example, optical downstream streams are received by node 70 at transceiver 72 and converted to digital downstream signals. Switch 74 and controller 76 reduce the noise of the digital downstream signals and then route the digital new band downstream signals to converter 78 and the digital legacy downstream signals to PHY device 80. The digital new band downstream signals are converted to analog QAM new band downstream signals via converter 78 and then routed through second filter 82 and first filter 84 to components downstream of node 70. Similarly, analog QAM new band upstream signals are received at first filter 84, routed to second filter 82, and then converted to digital new band signals by converter 78. Switch 74 and controller 76 reduce the noise of the digital new band signals and those signals are converted to optical new band upstream streams via transceiver 72 and are transmitted to the headend.

The digital legacy downstream signals from switch 74 are converted to analog QAM legacy downstream signals by PHY device 80. Those signals are amplified by second amplifier 90 and then routed through third filter 88 and first filter 84 to components downstream of node 70. Similarly, analog QAM legacy upstream signals are received by first filter 84 and routed to third filter 88 and then amplified by first amplifier 86. The amplified signals are converted to digital legacy upstream signals by PHY device 80. Switch 74 and controller 76 reduce the noise of the digital legacy upstream signals and then transceiver 72 converts those signals to optical legacy upstream signals and transmits the optical legacy upstream signals to the headend.

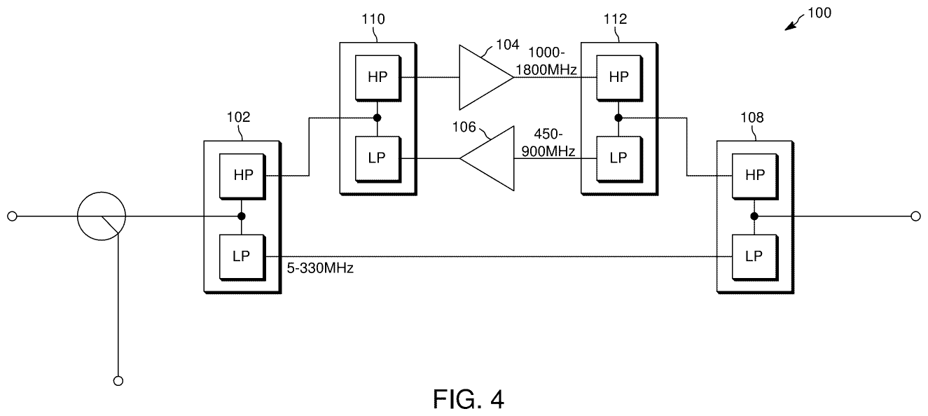

Referring to FIG. 4, an example of a tap apparatus or tap 16 is shown, which is generally indicated at 100. Unless explicitly excluded, tap 100 may include one or more components of one or more other taps and/or amplifiers described in the present disclosure. Tap 100 includes a first filter 102 to receive analog QAM downstream signals and separate analog QAM new band downstream signals from analog QAM legacy downstream signals. First filter 102 routes the analog QAM new band downstream signals to a third filter 110, and the analog QAM legacy downstream signals to a second filter 108.

Tap 100 also includes a first amplifier 104 to amplify analog QAM new band downstream signals from the first filter, and a second amplifier 106 to amplify analog QAM new band upstream signals from second filter 108. First amplifier 104 and/or second amplifier 106 amplify the analog QAM new band downstream and/or upstream signals by a magnitude different than that of the analog QAM legacy downstream and/or upstream signals. In some examples, the first and/or second amplifiers amplify the analog QAM new band downstream and/or upstream signals more than the analog QAM legacy downstream and/or upstream signals. Additionally, or alternatively, the first and/or second amplifiers amplify the analog QAM new band downstream and/or upstream signals by an amount less than amplification of those signal(s) at each of node 36 and/or 70. For example, the first and second amplifiers may amplify the analog QAM new band downstream and upstream signals by a gain of 20 dB and 15 dB, respectively. In the example shown in FIG. 4, tap 100 does not include any amplifiers that amplify the analog QAM legacy downstream and upstream signals. In other words, the analog QAM legacy downstream and upstream signals are not amplified by tap 100.

Additionally, tap 100 includes second filter 108 that receives analog QAM legacy downstream signals from first filter 102 and analog QAM new band downstream signals from a fourth filter 112 and routes those signals to components downstream of tap 100. Additionally, the second filter receives analog QAM upstream signals from components downstream of tap 100 and separates analog QAM new band upstream signals from analog QAM legacy upstream signals. Second filter 108 routes the analog QAM new band upstream signals to fourth filter 112, and routes the analog QAM legacy upstream signals to first filter 102.

Moreover, tap 100 includes third filter 110 disposed between first filter 102 and first and second amplifiers 104 and 106. The third filter routes analog QAM new band downstream signals from first filter 102 to first amplifier 104, and routes analog QAM new band upstream signals from second amplifier 106 to first filter 102. Moreover, tap 100 includes fourth filter 112 disposed between first and second amplifiers 104 and 106 and second filter 108. The fourth filter routes analog QAM new band downstream signals from first amplifier 104 to second filter 108, and routes analog QAM new band upstream signals from second filter 108 to second amplifier 106.

Tap 100 may be powered by the network and/or powered by the subscribers, such as via customer premises equipment. In some examples, tap 100 may include one or more automatic gain control circuits to ensure constant desired output level, and/or may include a microcontroller controlled by communication signals to provide control of gain or equalization. Although there are no amplifiers and/or filters between the first and second filters for analog QAM legacy signals (either upstream or downstream), other examples of tap 100 may include one or more amplifier and/or filters, such as similar to amplifiers 104 and 106, and third and fourth filters 110 and 112. Tap 100 may sometimes be referred to as an “amplified tap.”

As an example, analog QAM downstream signals are received by first filter 102 and analog QAM new band downstream signals are separated from analog QAM legacy downstream signals. The analog QAM new band downstream signals are routed to third filter 110, amplified by first amplifier 104, routed to fourth filter 112 and to second filter 108, and then to components downstream of tap 100. The analog QAM legacy downstream signals are routed from the first filter directly to second filter 108 (without any processing or routing by other components of tap 100 in between) and then to components downstream of tap 100. Similarly, second filter 108 receives analog QAM upstream signals and analog QAM new band upstream signals are separated from analog QAM legacy upstream signals. The analog QAM new band upstream signals are routed to fourth filter 112, amplified by second amplifier 106, routed to third filter 110, routed to first filter 102, and then to components upstream of tap 100. The analog QAM legacy upstream signals are routed to first filter 102 and then to components upstream of tap 100.

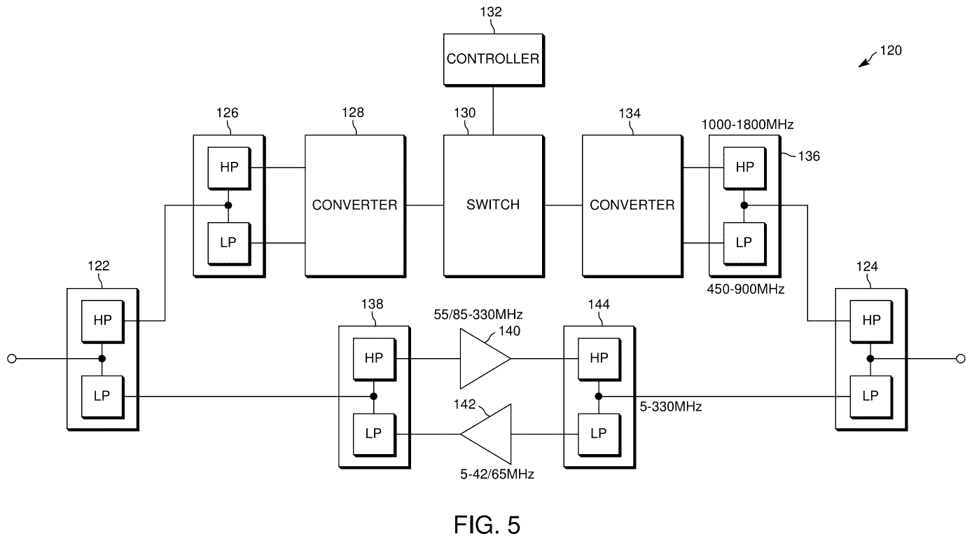

Referring to FIG. 5, an example of an amplifier 20 is shown, which is generally indicated at 120. Unless explicitly excluded, amplifier 120 may include one or more components of one or more other taps and/or amplifiers described in the present disclosure. Amplifier 120 includes a first filter 122 to receive analog QAM downstream signals and separate first analog QAM new band downstream signals from analog QAM legacy downstream signals. Amplifier 120 also includes a second filter 124 to receive analog QAM upstream signals and separate first analog QAM new band upstream signals from analog QAM legacy upstream signals.

Additionally, amplifier 120 includes a third filter 126 disposed between first filter 122 and a first converter 128. The third filter routes first analog QAM new band downstream signals from first filter 122 to first converter 128, and routes analog QAM new band upstream signals from first converter 128 to first filter 122. First converter 128 receives analog QAM new band downstream signals and converts those signals to digital new band downstream signals. Additionally, the first converter receives digital new band upstream signals from switch 130 and controller 132 and converts those signals to analog QAM new band upstream signals having less noise than the analog QAM new band upstream signals just prior to amplifier 120.

Moreover, amplifier 120 includes a switch 130 (such as an Ethernet switch) and a controller 132 that controls the switch. Switch 130 manages and reduces the noise of the digital new band upstream and downstream signals. Controller 132 may be a local controller or a remote controller. Amplifier 120 also includes a second converter 134 that converts the digital new band downstream signals with reduced noise from switch 130 to analog QAM new band downstream signals having less noise than the analog QAM new band downstream signals just prior to amplifier 120. Additionally, the second converter converts the analog QAM new band upstream signals to digital new band upstream signals. In some examples, first converter 128 and/or second converter 134 may amplify the digital new band upstream and/or downstream signals during and/or separate from the conversion process. In other examples, first converter 128 and/or second converter 134 does not amplify the digital new band upstream and/or downstream signals. An example of first and second converters 128 and 130 is a modulator/demodulator (or modem).

Furthermore, amplifier 120 includes a fourth filter 136 disposed between second converter 134 and second filter 124. The fourth filter routes analog QAM new band downstream signals from second converter 134 to second filter 124, and routes analog QAM new band upstream signals from the second filter to the second converter. Additionally, amplifier 120 includes a fifth filter 138 disposed between first filter 122 and first and second amplifiers 140 and 142. The fifth filter routes analog QAM legacy downstream signals from first filter 122 to first amplifier 140, and routes analog QAM legacy upstream signals from second amplifier 142 to first filter 122.

First amplifier 140 amplifies the analog QAM legacy downstream signals, while second amplifier 142 amplifies the analog QAM legacy upstream signals. First amplifier 140 and/or second amplifier 142 amplify the analog QAM legacy downstream and/or upstream signals by a magnitude different than that of the analog QAM new band downstream and/or upstream signals. In some examples, the first and/or second amplifiers amplify the analog QAM legacy downstream and/or upstream signals more than the analog QAM new band downstream and/or upstream signals. For example, the first and second amplifiers may amplify the analog QAM legacy downstream and upstream signals by 30 dB and 25 dB, respectively. In contrast, converters 128 and 134 may amplify the analog QAM new band downstream and upstream signals a gain of 50 dB and 40 dB, respectively. Moreover, amplifier 120 includes a sixth filter 144 disposed between second filter 124 and first and second amplifiers 140 and 142. The sixth filter routes analog QAM legacy downstream signals from first amplifier 140 to second filter 124, and routes analog QAM legacy upstream signals from second filter 124 to second amplifier 142.

As an example, amplifier 120 receives analog QAM downstream signals and those signals are separated into analog QAM new band downstream signals and analog QAM legacy downstream signals at first filter 122. The analog QAM new band downstream signals are routed to third filter 126 and then converted into digital new band downstream signals at first converter 128. Switch 130 and controller 132 reduce noise of the digital new band downstream signals and those signals are converted, at second converter 134, to analog QAM new band downstream signals having less noise than just prior to amplifier 120. Fourth filter 136 routes the analog QAM new band downstream signals to second filter 124 and to components downstream of amplifier 120. The analog QAM legacy downstream signals are routed to fifth filter 138, amplified at first amplifier 140, routed to sixth filter 144, routed to second filter 124, and then to components downstream of amplifier 120.

Additionally, amplifier 120 receives analog QAM upstream signals and those signals are separated into analog QAM new band upstream signals and analog QAM legacy upstream signals at second filter 124. The analog QAM new band upstream signals are routed to fourth filter 136 and then converted into digital new band upstream signals at second converter 134. Switch 130 and controller 132 reduce noise of the digital new band upstream signals and those signals are converted, at first converter 128, to analog QAM new band upstream signals having less noise than just prior to amplifier 120. Third filter 126 routes the analog QAM new band upstream signals to first filter 122 and to components upstream of amplifier 120. The analog QAM legacy upstream signals are routed to sixth filter 144, amplified at second amplifier 142, routed to fifth filter 138, routed to first filter 122, and then to components upstream of amplifier 120.

An example of a suitable device for the filters described above is a bandpass filter having a high pass (HP) filter that allows high-frequency (or new band) upstream signals (e.g., 450-900 MHz) and high-frequency (or new band) downstream signals (e.g., 1000-1800 MHz) through, and a low pass (LP) filter that allows low-frequency (or legacy) upstream signals (e.g., 5-42 MHz or 5 -65 MHz) and low-frequency (or legacy) downstream signals (e.g., 55-330 MHz or 85-330 MHz) through.

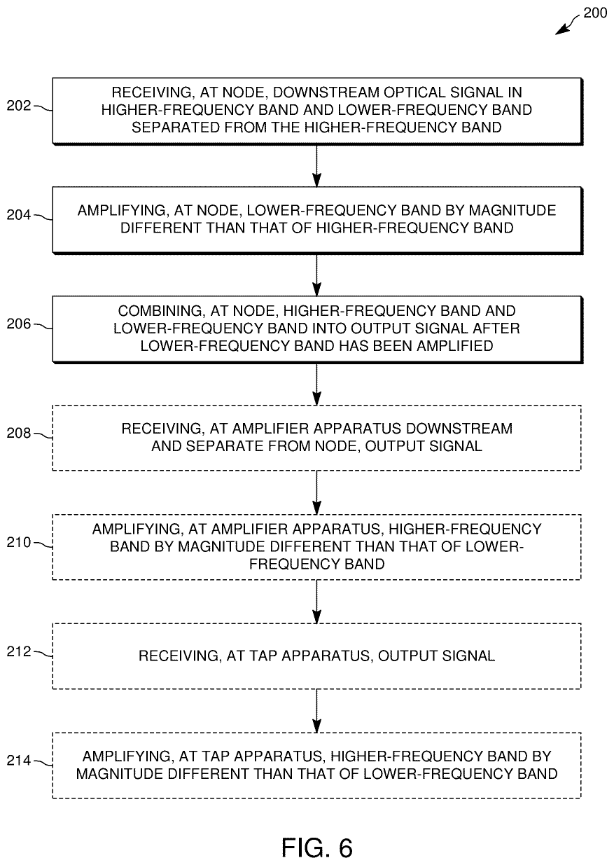

Referring to FIG. 6, a flowchart is shown of an example of a method of managing signals in a HFC network, which is generally indicated at 200. At 202, a downstream optical signal in a higher-frequency band and a lower-frequency band separated from the higher-frequency band is received at a node. For example, a transceiver and photodiode may receive the downstream optical signal and generate a higher-frequency band signal and a lower-frequency band signal, respectively. Alternatively, a transceiver may receive the downstream optical signal and generate the higher-and lower-frequency band signals via a switch and/or controller.

At 204, the lower-frequency band may be amplified at the node by a magnitude different than that of the higher-frequency band (or different from the amplification of the higher-frequency band at the node). For example, amplification of the lower-frequency band at the node may be greater than amplification of the higher-frequency band at the node. In some examples, the higher-frequency band is not amplified at the node (or not amplified prior to when the higher-frequency and lower-frequency bands are combined). Amplification may be performed by one or more converters, one or more amplifiers, etc.

At 206, the higher-frequency band and the lower-frequency band are combined at the node into an output signal, such as after the lower-frequency band has been amplified. For example, the higher-frequency band and the lower-frequency band may be combined by one or more filters.

In some examples, method 200 may include, at 208, receiving the output signal at a plurality of amplifier apparatus that are downstream and separate from the node. Additionally, at 210, the higher-frequency band may be amplified, at the plurality of amplifier apparatus, by a magnitude different than that of the lower-frequency band (or different from the amplification of the lower-frequency band). For example, amplification of the lower-frequency band at the plurality of amplifier apparatus may be greater than amplification of the higher-frequency band at the plurality of amplifier apparatus.

In some examples, method may include, at 212, receiving the output signal at one or more tap apparatus. Additionally, at 214, the higher-frequency band may be amplified at the one or more tap apparatus by a magnitude different than that of the lower-frequency band (or different from amplification of the lower-frequency band). For example, amplification of the higher-frequency band at the one or more tap apparatus may be more than amplification of the lower-frequency band at the one or more tap apparatus and/or less than amplification of the lower-frequency band at the node. In some examples, amplification of the lower-frequency band is not performed at the one or more tap apparatus. Although FIG. 6 shows particular steps for a process of managing signals in a HFC network, other examples of the process may add, omit, replace, repeat, and/or modify one or more steps.

The HFC network, its components, and methods of managing signals of the present disclosure provides a backward-compatible network but also supports bi-directional gigabit services. The HFC network also has low latency, a simple network design and deployment, low power needs that stay within current HFC plan design power capabilities, and support designs with one or more nodes. Additionally, the HFC network provides distributed low power amplification of the analog QAM new band downstream and/or upstream signals that is more frequent but in an amount less than the analog QAM legacy downstream and/or upstream signals. For example, the maximum distance between components that amplify the analog QAM new band downstream and/or upstream signals may be 600 feet.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of managing signals in a hybrid fiber-coaxial (HFC) network, comprising:
receiving, at a node, a downstream optical signal, wherein said received downstream optical signal having a higher-frequency band and a lower-frequency band, wherein said lower-frequency band is at least partially overlapping in frequencies with said higher-frequency band, wherein said higher-frequency band has frequencies that are greater than any frequencies in said lower-frequency band, wherein said node separates said lower-frequency band from said higher-frequency band, where the separated lower-frequency band includes frequencies included in said separated higher-frequency band;
amplifying, at the node, said lower-frequency band by a magnitude different than that of the higher-frequency band for said partially overlapping frequencies; and
combining, at the node, the result of said amplifying said higher-frequency band and the lower-frequency band into an output signal that is transmitted from said node.

2. The method of claim 1, wherein amplification of the lower-frequency band is greater than amplification of the higher-frequency band.

3. The method of claim 2, wherein the higher-frequency band is not amplified prior to the step of combining.

4. The method of claim 2, further comprising:
receiving, at a plurality of amplifier apparatus downstream and separate from the node, the output signal; and
amplifying, at the plurality of amplifier apparatus, the higher-frequency band by a magnitude different than that of the lower-frequency band.

5. The method of claim 4, wherein amplification of the lower-frequency band at the plurality of amplifier apparatus is greater than amplification of the higher-frequency band at the plurality of amplifier apparatus.

6. The method of claim 1, further comprising:
receiving, at one or more tap apparatus, the output signal; and
amplifying, at the one or more tap apparatus, the higher-frequency band by a magnitude different than that of the lower-frequency band.

7. The method of claim 6, wherein amplification of the higher-frequency band at the one or more tap apparatus more than amplification of the lower-frequency band at the one or more tap apparatus.

8. The method of claim 7, wherein amplification of the lower-frequency band is not performed at the one or more tap apparatus.

9. The method of claim 6, wherein amplification of the higher-frequency band at the one or more tap apparatus is by an amount less than the amplification of the lower-frequency band by the node.

10. The method of claim 1, wherein the higher-frequency band is 1000 to 1800 MHz.

11. The method of claim 1, wherein the lower-frequency band is 55 to 400 MHz.

12. The method of claim 11, wherein the lower-frequency band is 55 to 330 MHz.

13. The method of claim 11, wherein the lower-frequency band is 85 to 330 MHz.

14. The method of claim 11, wherein the lower frequency band is 85 to 400 MHz.

15. The method of claim 1, wherein the lower frequency band is 108 to 684 MHz.

16. The method of claim 15, wherein the lower frequency band is 108 to 300 MHz.

17. The method of claim 15, wherein the lower frequency band is 108 to 492 MHz.
